(19) United States
(12) Patent Application Publication
(10) Pub. No.: US 2010/0118048 A1
(43) Pub. Date: May 13, 2010

(54) SYSTEM AND METHOD FOR PROVIDING NESTED CONTROLS FOR MANIPULATING A DIGITAL IMAGE IN AN IN-BROWSER IMAGE EDITING APPLICATION

(75) Inventors: Brian Terry, Seattle, WA (US); Peter Roman, Seattle, WA (US)

Correspondence Address: GRAYBEAL JACKSON LLP, 400 - 108TH AVENUE NE, SUITE 700, BELLEVUE, WA, 98004, US

(73) Assignee: BITNIK, INC., Seattle, WA (US)

(21) Appl. No.: 12/268,300

(22) Filed: Nov. 10, 2008

(51) Int. Cl. G09G 5/02; G09G 5/00; G06F 3/048

(52) U.S. Cl. 345/594; 345/581; 715/733

(57) ABSTRACT

A system and method for providing nested controls for manipulating a digital image. A system may typically include a client computer having a web browser application executing thereon and having an in-browser image manipulation application executing within the context of the web browser application. Such an in-browser image manipulation application may be operated by a user to display a digital image to be manipulated. A user may select an editable feature, such as color scheme or brightness, of the digital image. In response to selecting the editable feature, the application may display the control feature adjacent to the digital image such that a user may manipulate the control feature in real-time. In response to manipulating the control feature, changes to the digital image are displayed in real-time.

### BACKGROUND

Digital photo editing and digital photo editors are common in today's digital photography technology. In digital editing, photographs are typically taken with a digital camera and input directly into a computer for storage and manipulation. Additionally, traditional printed photograph may be digitized using a scanner and also stored and manipulated on a computer. Photos can also be stored and obtained from stock photography databases. With the advent of computers, graphics tablets, and digital cameras, the term photo editing encompasses everything that can be done to a photo in a darkroom or on a computer. Photo editing is most commonly subtle (e.g. alterations to coloring, contrast, so forth), but may be explicit also (e.g. overlaying a head onto a different body, changing a sign's text). Image editing software can be used to apply effects and warp an image in whatever way possible until the desired result is achieved. Image editing software can also be used to create images from scratch for example with tools for drawing or adding text. Sometimes, after photo editing, the resulting image has little or no resemblance to the photo from which it started.

Digital image editing computer programs are prevalent and easily accessible and provide a means that allows any computer to be used for digital photo editing. Often times, a standalone software package may be purchased and installed on a personal computer or in a computer networking environment. These conventional software programs allow for digital photos to be manipulated and saved at the local machine in which the photo editing software is running. Thus, a user of personal computer with such photo editing software may easily manipulate any number of digital photos that are also stored at that computer. In this scenario, the task-intensive steps of actual photo manipulation are accomplished by the personal computer.

Further, various networking environments may allow photo editing software to be run at some accessible server computer such that images are manipulated at the server computer at the behest of the connected client computer. In this scenario, the task-intensive steps of actual photo manipulation are accomplished by the server computer that hosts the photo editing software and the client computer merely acts as a controller.

With the advent of web sites and server farms capable of storing a tremendous amount of data, various computer users have begun storing digital photos in online storage services. In this manner, a person may access stored digital photos from any computer that the person may be using. With universal access to stored digital photos, one may upload photos from virtually anywhere and store the digital photos in an online manner. However, well-known and comprehensive photo editing software may only be resident on one personal computer or within a specific network of computers. Thus, even if a person is able to upload and store their newly created digital photos from any computer connected to the internet, the person cannot access their photo editing software to manipulate the newly created and stored digital photos.

Furthermore, different editing tools available to a user, whether user is using a powerful image editing application or a simple web-based editor, have limitations in their capabilities and attributes. For example, several editing applications allow a user to adjust certain attributes of an image one at a time. That is, a user may wish to adjust a certain color (e.g., a cyan color) within an image. As such the user accesses a control that allows the user to adjust the level of cyan in the image. Likewise, the user may then wish to access a second control to adjust a different color level (e.g., magenta) so as to help balance the affects of previously adjusting the cyan level. Invariably, then the user may adjust yet another control to further adjust the colors of the image. As a result, the user is juggling the adjustment of several controls at once to achieve a desired result, which may be a blended image adjustment such as, for example, sepia tone or black and white tones. Multiple adjustments of multiple image editing controls are confusing and inefficient.

What is needed is a more convenient set of editing controls in an image editing application that allows a user more efficiency and greater control over image manipulations.

### BRIEF DESCRIPTION OF THE DRAWINGS

The foregoing aspects and many of the attendant advantages of the subject matter disclosed herein will become more readily appreciated as the same become better understood by reference to the following detailed description, when taken in conjunction with the accompanying drawings, wherein:

FIG. 1 shows a diagram of a suitable computing environment for practicing various aspects of an in-browser photo editing system and method according to an embodiment of the subject matter disclosed herein;

FIG. 2 is a diagram of a suitable computing network for practicing various aspects of an in-browser photo editing system and method according to an embodiment of the subject matter disclosed herein;

FIG. 3 is a flow chart of a method for providing nested controls for manipulating a digital image in an in-browser image editing application according to an embodiment of the subject matter disclosed herein;

FIG. 4 is a screenshot of an in-browser photo-editing application suitable for providing nested controls for manipulating a digital image according to an embodiment of the subject matter disclosed herein; and

FIG. 5 is a screenshot of an in-browser photo-editing application suitable for providing editing options of digital images using nested controls according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the subject matter disclosed herein. This disclosure is not intended to be limited to the embodiments shown, but is to be accorded the widest scope consistent with the principles and features disclosed or suggested herein.

By way of overview, an embodiment of the subject matter disclosed herein disclosed herein is described in the following paragraphs. One embodiment comprises a client computer having a web browser application executing thereon and having an in-browser image manipulation application executing within the context of the web browser application. Such an in-browser image manipulation application may be operated by a user to display a digital image to be manipulated. A user may select an editable feature, such as color scheme or brightness, of the digital image. In response to selecting the editable feature, the application may display the control feature adjacent to the digital image such that a user may manipulate the control feature in real-time. In response to manipulating the control feature, changes to the digital image are displayed in real-time.

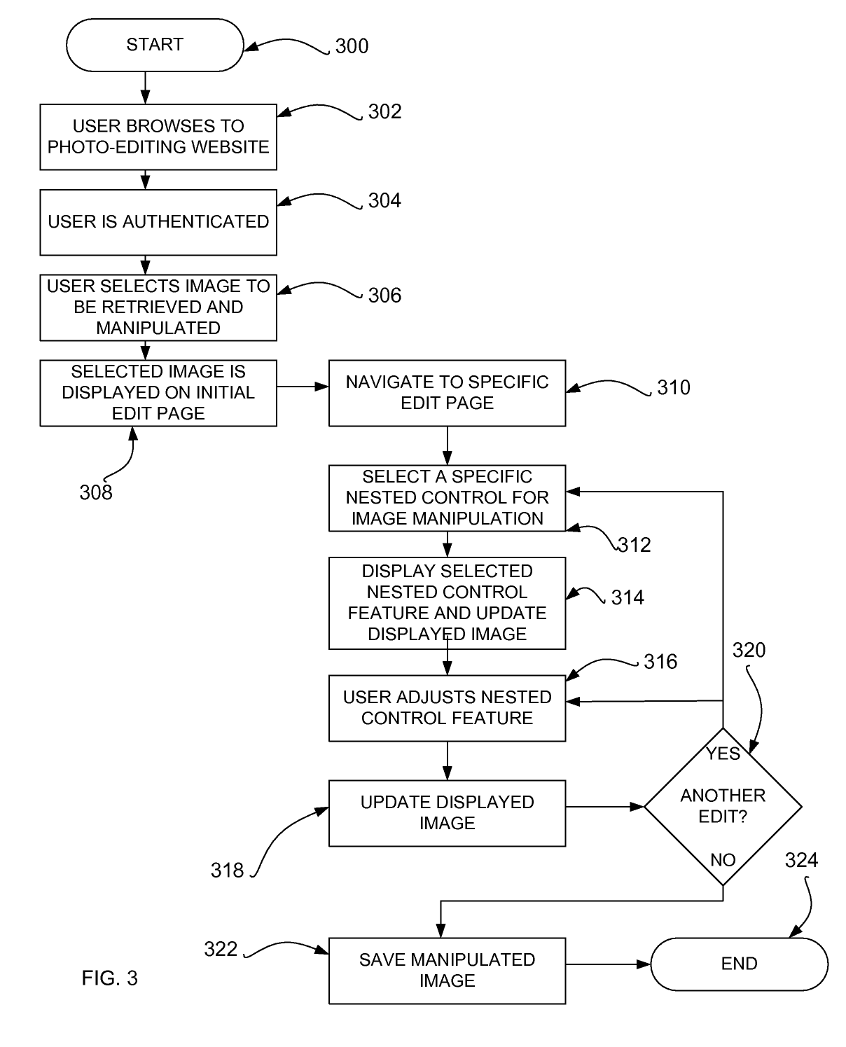

Such a system and method provides several advantages over the prior art. First, as a user may manipulate multiple attributes (e.g., several colors at once) of an image simultaneously while being able to monitor the manipulated image during the manipulations in real-time. Further, the user can more efficiently change multiple attributes in common and popular manners without having to manipulate each individual attribute to achieve a blended result. Such nested controls allow a user to more quickly and easily try different adjustments to multiple attributes at the same time to achieve a desired result. For example, several individual colors may be diminished at once using a nested control to achieve an image that is very dull for an aged look and feel. Several other nested control examples are discussed below with respect to FIG. 3-5.

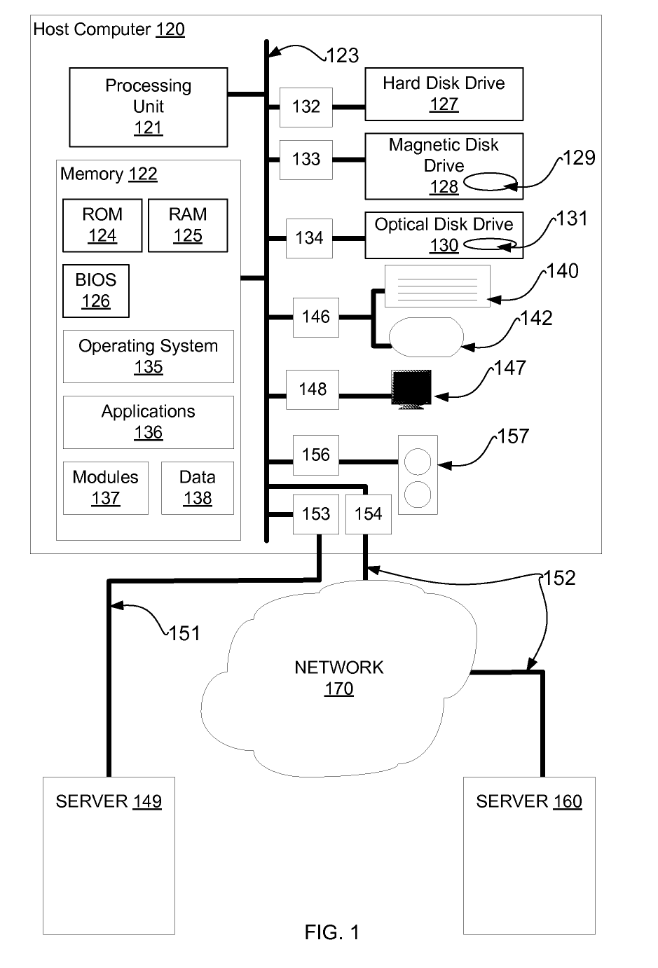

FIG. 1 and the following discussion are intended to provide a brief, general description of a suitable computing environment in which the subject matter disclosed herein may be implemented. Although not required, aspects of a system and method for providing nested controls for the manipulation of a digital image as may be used within an in-browser photo editing system and method will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that the subject matter disclosed herein may be practiced with other computer system configurations, including hand-held devices, cellular or mobile telephones, multiprocessor systems, microprocessor-based or programmable consumer electronics, network PCs, minicomputers, mainframe computers, and the like. The methods and systems may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the systems and methods disclosed herein includes a general purpose computing device in the form of a conventional personal computer 120, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory includes read only memory (ROM) 124 and random access memory (RAM) 125. A basic input/output system (BIOS) 126, containing the basic routines that help to transfer information between elements within the personal computer 120, such as during start-up, is stored in ROM 124. The personal computer 120 further includes a hard disk drive 127 for reading from and writing to a hard disk, not shown, a magnetic disk drive 128 for reading from or writing to a removable magnetic disk 129, and an optical disk drive 30 for reading from or writing to a removable optical disk 131 such as a CD ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the personal computer 120. Although the exemplary environment described herein employs a hard disk, a removable magnetic disk 129 and a removable optical disk 131, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk 129, optical disk 131, ROM 124 or RAM 125, including an operating system 135, one or more application programs 136, other program modules 137, and program data 138. A user may enter commands and information into the personal computer 120 through input devices such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus, but may be connected by other interfaces, such as a parallel port, game port or a universal serial bus (USB). A monitor 147 or other type of display device is also connected to the system bus 123 via an interface, such as a video adapter 148. One or more speakers 157 are also connected to the system bus 123 via an interface, such as an audio adapter 156. In addition to the monitor and speakers, personal computers typically include other peripheral output devices (not shown), such as printers.

The personal computer 120 operates in a networked environment using logical connections to one or more remote computers, such as remote computers 149 and 160. Each remote computer 149 or 160 may be another personal computer, a server, a router, a network PC, a peer device or other common network node, and typically includes many or all of the elements described above relative to the personal computer 320, although only a memory storage device 150 or 161 has been illustrated in FIG. 1. The logical connections depicted in FIG. 1 include a local area network (LAN) 151 and a wide area network (WAN) 152. Such networking environments are commonplace in offices, enterprise-wide computer networks, intranets and the Internet. As depicted in FIG. 1, the remote computer 160 communicates with the personal computer 120 via the local area network 151. The remote computer 149 communicates with the personal computer 120 via the wide area network 152.

When used in a LAN networking environment, the personal computer 120 is connected to the local network 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

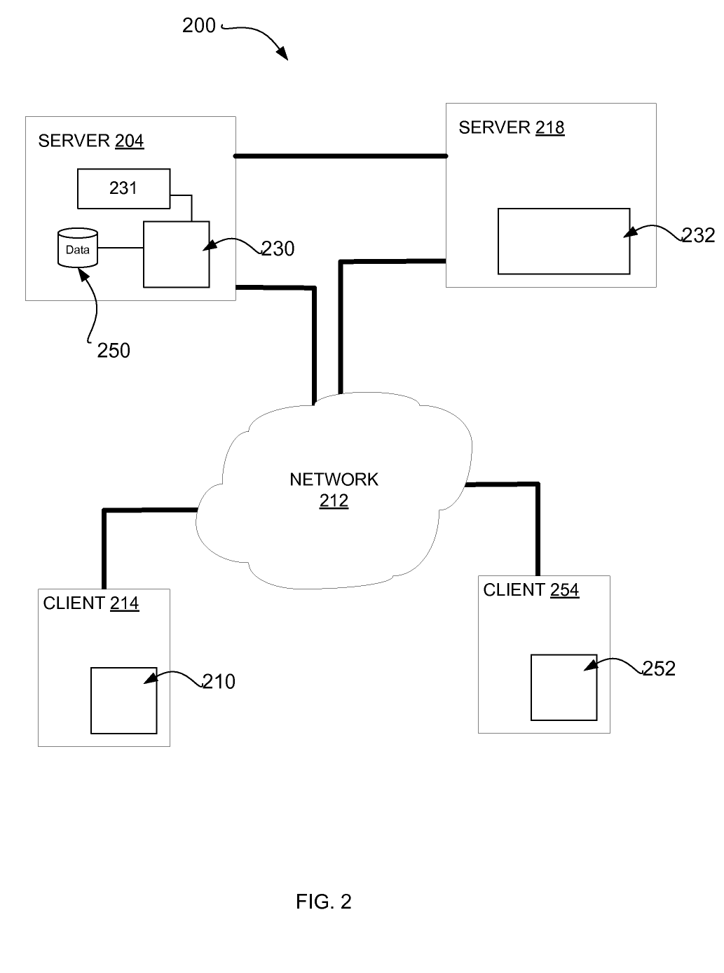

FIG. 2 illustrates an exemplary architecture of a networked computer system in which aspects of an in-browser photo editing application may be practiced. The computer network 216 may be a local area network 151 (FIG. 1), a wide area network 152 (FIG. 1), or a combination of networks that allow the server computer 204 to communicate with remote computers, such as the remote server computer 218, either directly or indirectly. The server computer 204 and the remote server computer 218 are typically similar to the personal computer 120 depicted in FIG. 1 and discussed above.

Such a computer network 216 allows for the sending and receiving of data associated with digital images that may be used with an in-browser photo editing system. Such data may be stored in a database 250 on a server computer 204. This data may be updated, assimilated and/or altered according to additional data sent and received to and from various other computers in the computer network such as server computer 218 and client computers 214 and 254.

With such a computer network, a system for manipulating digital image in a computer-network environment may be realized. A typical system includes a client computer 214 having a web browser application executing thereon and having an in-browser image manipulation application executing within the context of the web browser application. Typically, a client computer will have a dedicated web browsing application, such as Internet Explorer™ from the Microsoft™ Corporation such that when browsing web pages over the Internet, a set of default rules and applications are implemented to accomplish all web-browser related activities. The web browser application may also be any other common web browser such as Mozilla Firefox, Netscape Navigator, and Safari. The web browser may be used to navigate and utilize web sites and web applications. One specific web application may be an in-browser photo editor as described herein. This in-browser photo editor and methods associated therewith are described in more detail below with respect to FIG. 3.

The system may further include a server computer 254 communicatively coupled to the client computer 214 over the computer network. In one embodiment, the server computer includes an image manipulation service executing thereon, such that a client computer 214 may invoke the service via the Internet connection. With that, the in-browser photo editor includes an image manipulation application that is operable to handle a number of image manipulation tasks. In an abstract form then, the application may receive an instruction for manipulating an image (e.g., an instruction to crop, rotate, resize, etc.) and determine whether the manipulation is more efficiently executed at the client computer 214 or at the server computer 218.

The system may further include a remote computer 254 communicatively coupled to the client computer 214 and the server computer 254. The remote computer may be used for additional storage and manipulation of images such that it is operable to store digital images for the client computer 214 to retrieve for manipulation. Various methods associated with the system described in FIG. 2 are presented below with respect to FIGS. 3-5.

FIG. 3 shows a flow diagram of a method for providing nested controls for manipulating a digital image in an in-browser photo editing application according to an embodiment of the subject matter disclosed herein. The method of FIG. 3 may typically be carried out in a computer networking environment as described above and in the form of computer-executable instructions encoded on a computer-readable medium.

As an overview, one method may typically include selecting a control feature associated with a digital image, such as a “black and white” control feature, a “sepia-tone” control feature, etc. Further, the method may include displaying a fine-tune control feature for the selected control feature and then adjusting said fine-tune control feature and displaying a change to the digital image on a display, the change typically associated with the adjustment of the at least two attributes. These and other features are better understood in the details below.

In FIG. 3, the method shown herein starts at step 300. The method is typically practiced on a personal computer (such as the personal computer of FIG. 1) and typically employs a suitable web-browsing application such as Microsoft Internet Explorer™ or Firefox™. At step 302, a user may browse to a photo-editing website using the web-browser application of the personal computer. Such an in-browser photo-editing application is described in further detail in separate related U.S. patent application Ser. No. 12/051,337 entitled “SYSTEM AND METHOD FOR IN-BROWSER PHOTO EDITING” and is hereby incorporated by reference.

Once the initial website is displayed on a display, the user may choose to authenticate his or her identity by engaging in an authentication procedure at step 304. The authentication procedure allows the user to be identified and provide access to data stored on one or more server computers, such as stored digital images and photographs as well as associated editing histories for each stored image or photograph. The authentication procedure may typically be a cookie-based identity schema or a username and password schema as is known in the art.

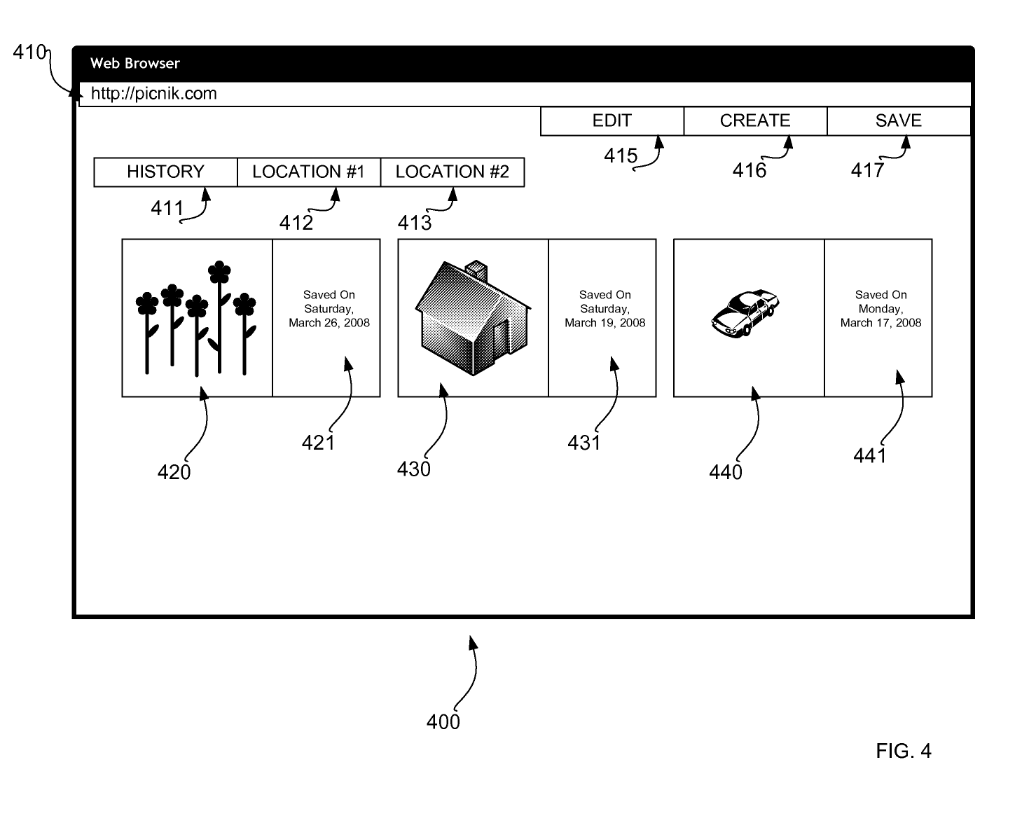

Once authenticated, the method continues at step 306 as the user may then select an image to be manipulated. The image to be manipulated may be stored in a local memory (e.g., a hard-disk drive of FIG. 1) or may be retrieved from a remote location (e.g., a data store 250 of FIG. 2). Several examples of remote locations include such known web services such as Yahoo™, Facebook™, Flickr™, etc. Once retrieved, in step 306, the selected image may be displayed on an initial edit page, such as an edit page shown in FIG. 4. This view of the display at this point in the method is shown with detail in FIG. 4 and is discussed next before proceeding with the remainder of the method of FIG. 3.

FIG. 4 is a screenshot of an in-browser photo-editing application suitable for providing nested controls for manipulating a digital image according to an embodiment of the subject matter disclosed herein. In this screenshot 400, a typical address bar 410 shows a website that a user may browse to engage the method of FIG. 3. Here, a user may have already been authenticated and several images have been retrieved and displayed. A first image thumbnail 420 of an image of flowers is shown first with associated set of first image data 421, such as when the image was last saved. Likewise, a second image thumbnail 430 of a house and its associated image data 431 as well as a third image thumbnail 440 with its associated image data 441 is displayed in this view.

Additional controls may be present for the user to retrieve more images, such as additional history 411, location #1 412, and location #2 413 that may correspond to remote web services such as Flickr™ and Facebook™. Further, as a user may select a specific image to manipulate, additional navigational controls allow the user to display additional control features. More specifically, a user may select an edit button 415 to display additional editing control features, a create button 416 to display additional creative control features and a save button 417 to display additional save options. These control features and options are discussed in more detail as the discussion returns to the method of FIG. 3.

The user may select a specific image to edit and choose to display a set of editing control features by selecting the edit button 415 at step 310. In a next screen, a user may have a choice of several editing control features from which to choose. Such editing features may typically include rotate, crop, auto-fix, resize, color-change, exposure, etc. As one of the control features is selected, additional options may be displayed for the particular editing control feature. For example, if the exposure editing control feature is selected, additional control features for contrast and exposure may be displayed adjacent to the digital image in a user-manipulatable control feature. Those skilled in the art will appreciate the great number of image editing control features that may be incorporated in this system and method.

Another path in which the user may choose includes selecting the create button 416, also at step 310. In a next screen, a user may have a choice of several creative control features from which to choose. Such creative control features may typically include touch-up, special effects, and advanced creative features.

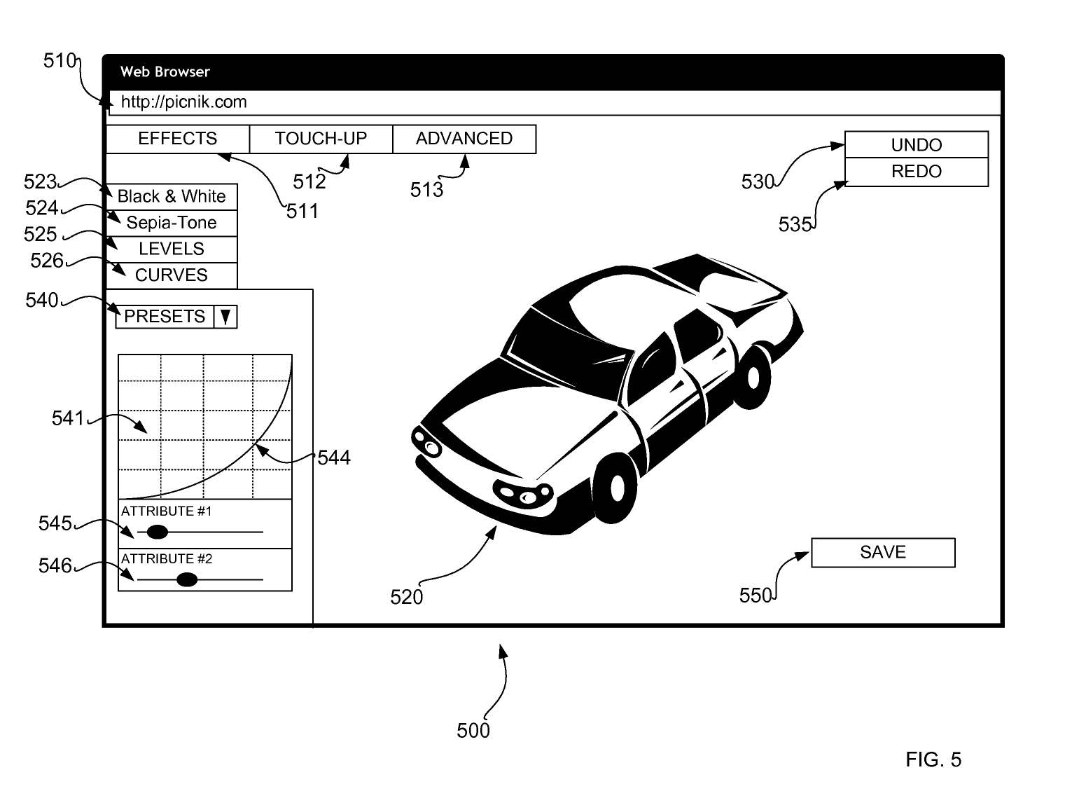

Within the context of this application, both the edit control feature and the creative control features may include more advanced control features that may be nested for ease of use by the user. A nested control feature may include at least one controllable element displayed on a nested control display in which a user may maneuver a control (e.g., a slider control, a maneuverable line in a graph, etc.) wherein the manipulation of such a control feature changes several editable attributes of an image. Such nested control features associated with the edit screen and the create screen are described in more detail below with respect to FIG. 5.

Within the context of the method of FIG. 3, a user may select a specific nested control feature for image manipulation at step 312. In some cases, the selected nested control feature may immediately effectuate a change to the displayed image. This may be referred to as a course-tune control feature because the edits made to the displayed image are substantial and immediate. For example, if the user selects a “black and white” control feature, the image may then be changed in real-time to an initial starting point wherein the displayed image is now displayed in black and white colors only.

Additionally, the selected nested control feature may have an additional fine-tune control feature that may be displayed adjacent to the image to be manipulated at step 314 in a convenient location that does not interfere with the display of the image. With the course-tune adjustment already implemented and displayed, a user may then further manipulate the selected fine-tune control feature now displayed to adjust the control feature at step 316 in order to change and manipulate the image according the user's desire in a more precise manner. For example, after the image has been changed to be displayed in black and white only, the user may now adjust the relative ratios of black to white in the displayed image. As the user adjusts the fine-tune control feature, the image displayed is updated (e.g., changes are displayed in real-time) to reflect the changing of the control feature at step 318.

If there are additional manipulations (i.e., edits) to be made with the selected nested control feature, then the method loops back through the decision block 320 to the user adjustment step at step 316. Further, if the user wishes to make different adjustments using a different nested control feature, the method may loop back through the decision block 320 to the user selection step at step 312. If no other edits are to be made, then the image may be saved at step 322 and the method comes to an end at step 324. Of course, those skilled in the art will appreciate that these steps as described in the method according to FIG. 3 may be maneuvered and manipulated in several combinations and permutations. The method of FIG. 3 will be better understood with reference to the screenshot of FIG. 5 and through the following nested control examples.

FIG. 5 is a screenshot of an in-browser photo-editing application suitable for providing editing options of digital images using nested control features according to an embodiment of the subject matter disclosed herein. In this screenshot 500, a digital image of a car 520 has been selected and displayed as a full image (as opposed to a thumbnail in the previous screenshot 400 of FIG. 4). Again, a Web address bar 510 may be present near the top of the screen shot 500. From the screen, a user has a number of options for manipulating an editing the image 520.

Two such options are shown in the upper right-hand corner as an undo instruction 530 and a redo instruction 535 embodied in the form of user selectable interface buttons. Further, additional user interface buttons are shown with typical image manipulation instructions available to the user. In the upper left-hand corner of the screen shot, there is shown three examples of additional image manipulation instructions available for the user to implement: a special effects button 511, a touch-up button 512, and an advanced menu button 512 which may allow the user to more advanced image manipulation instructions available that typically include nested controls. Such nested controls are described in further detail below. Those skilled in the art will understand that any number of image manipulation instructions may be available to user of an in browser photo editing application such as the one discussed throughout this disclosure. Finally, at any time during current editing session, the user may save the manipulated image of the car 520 by selecting the save button 550.

Various nested control features may be displayed on the left of the screen. A user may select any of these control features, such as, black and white control feature 523 or a sepia-tone control feature 524. At the selection time, a course-tune changes is immediately implemented at the digital image 520 while a fine-tune control is then displayed near the image. For example, a user may select the black and white control feature 523 and the image 520 is then immediately changed to black and white. Similarly, the user may then select the sepia-tone control feature 524 and the image 520 is immediately changed to a sepia tone (while the black and white changes are discarded). Thus, a user may quickly step through all control features on the left without having to reload new screens for each control feature as the fine-tune control features are merely displayed on the left near the image 520.

Two additional nested control features shown in the screen shot 500 includes a Levels nested control 525 and a Curves nested control 526. As a user selects one of the nested control buttons, unique controls specific to the selected nested control is displayed on the screen next to the image to be manipulated. Here, the Curves nested control has been selected and a Curves interface is shown in the lower left hand corner.

In this interface, a user may use the control features to adjust various color attributes of the image. Such color attributes may typically include a red attribute, a green attribute and a blue attribute as is commonly associated with an RGB (red-green-blue) color schema for imaging. With such attributes able to be adjusted, a user may manipulate a single control (in this feature, the single control is a maneuverable line 544 on a graphicsal interface 541) such that each of the color attributes are adjusted as the user maneuvers sections of the line in, out, and around. Thus, as the graphical line (representing a red color attribute, a green color attribute and a blue color attribute) is maneuvered by a user, the various attributes of the image may be adjusted at varying rates. That is, in response to maneuvering the line, the red color attribute may be adjusted at a first rate, the green color attribute may be adjusted at a second rate; and the blue color attribute may be adjusted at a third rate.

Further, additional associated attributes 545 and 546 may also be diplayed with a user-maneuverable control. Such associated controls may include a color override feature and a fade feature. Further yet, specific presets 540 may be available wherein the selection of a preset automatically adjusts each attribute to a starting point. Such presets may typically include sepia, faded, washed out, bright, etc.

While the subject matter discussed herein is susceptible to various modifications and alternative constructions, certain illustrated embodiments thereof are shown in the drawings and have been described above in detail. Furthermore, those skilled in the art will understand that various aspects described in less than all of the embodiments may, nevertheless, be present in any embodiment. It should be understood, however, that there is no intention to limit the subject matter to the specific forms disclosed, but on the contrary, the intention is to cover all modifications, alternative constructions, and equivalents falling within the spirit and scope of the subject matter disclosed herein.

What is claimed is:

1. In an in-browser photo editing computer application, a method comprising:
displaying a digital image to be manipulated on a display;
selecting an editable feature of the digital image, the editable feature associated with a control feature in the in-browser photo editing application;
in response to selecting the editable feature, displaying the control feature adjacent to the digital image;
manipulating the control feature in real-time; and
in response to manipulating the control feature, displaying a change to the digital image on the display in real-time.

2. The method of claim 1, wherein the manipulating the control feature comprises sliding a slide control using an input device.

3. The method of claim 1, further comprising retrieving an image to be manipulated from a remote location.

4. The method of claim 1, further comprising saving instructions corresponding to image manipulations in a photo history.

5. The method of claim 1 wherein the control feature comprises manipulating a curves control feature, the manipulation comprising:
maneuvering a graphical line representing a red color attribute, a green color attribute and a blue color attribute; and
in response to maneuvering the line:
adjusting the red color attribute at a first rate;
adjusting the green color attribute at a second rate; and
adjusting the blue color attribute at a third rate.

6. The method of claim 1 wherein the one control feature comprises manipulating a levels control feature, the manipulation comprising:
maneuvering a slider control representing a red color attribute, a green color attribute and a blue color attribute
in response to maneuvering the line:
adjusting the red color attribute at a first rate;
adjusting the green color attribute at a second rate; and
adjusting the blue color attribute at a third rate.

7. The method of claim 1 wherein the control feature comprises a nested control feature that includes at least one other nested control feature.

8. A system for editing a digital image, the system comprising:
a client computer having a web browser application executing thereon and having an in-browser image manipulation application executing within the context of the web browser application; and
a server computer communicatively coupled to the client computer over a computer network, the server computer having a plurality of images stored thereon, each image associated with an editing history;
wherein the in-browser image manipulation application is operable to:
display a digital image to be manipulated on a display;
select an editable feature of the digital image, the editable feature associated with a control feature in the in-browser photo editing application;
in response to selecting the editable feature, display the control feature adjacent to the digital image;
manipulate the control feature in real-time; and
in response to manipulating the control feature, display a change to the digital image on the display in real-time.

9. In a photo editing computer application, a method comprising:
displaying a digital image to be manipulated on a display;
selecting an editable feature of the digital image, the editable feature associated with a control feature in the in-browser photo editing application;
in response to selecting the editable feature, displaying a first control feature adjacent to the digital image;
manipulating the first control feature in real-time; and
in response to manipulating the first control feature, displaying a change to the digital image on the display in real-time and displaying a second control feature adjacent to the digital image.

10. The method of claim 9, further comprising:
manipulating the second control feature in real-time; and
in response to manipulating the second control feature, displaying a change to the digital image on the display in real-time.

11. The method of claim 9 wherein the first control feature and the second control feature comprise a nested control relationships such that the first control feature comprises a course-tune control feature of the editable feature and the second control feature comprises a fine-tune control feature of the editable feature.

12. The method of claim 9, further comprising actuating an apply control feature operable to apply the manipulations to the digital image.

13. The method of claim 9, further comprising actuating a cancel control feature operable to cancel the manipulations to the digital image.

14. The method of claim 9, further comprising actuating a record changes control feature operable to save the manipulations to the digital image to an editing history.

15. In an in-browser photo editing computer application, a method comprising:
displaying a digital image to be manipulated on a display;
displaying a plurality of control features adjacent to the digital image;
selecting a first control feature from the plurality of control features and displaying a first change to the digital image on the display in real-time; and
selecting a second control feature from the plurality of control features and displaying a second change to the digital image on the display in real-time, the second change independent of the first change.

16. The method of claim 15, further comprising discarding the first change when the second control feature is selected.

17. The method of claim 15, further comprising displaying a first fine-tune control feature adjacent to the digital image after selecting the at least one control feature; and
removing the first fine-tune control feature and displaying a second fine-tune control feature adjacent to the digital image after selecting the at least one second control feature.

18. A computer readable medium having computer-executable instructions for:
displaying a digital image to be manipulated on a display;
selecting an editable feature of the digital image, the editable feature associated with a control feature in the in-browser photo editing application;
in response to selecting the editable feature, displaying the control feature adjacent to the digital image;
manipulating the control feature in real-time; and
in response to manipulating the control feature, displaying a change to the digital image on the display in real-time.

19. The computer readable medium of claim 18 having further computer-executable instructions for:
maneuvering a graphical line representing a red color attribute, a green color attribute and a blue color attribute; and
in response to maneuvering the line:
adjusting the red color attribute at a first rate;
adjusting the green color attribute at a second rate; and
adjusting the blue color attribute at a third rate.

20. The computer readable medium of claim 19 having further computer-executable instructions for:
maneuvering a slider control representing a red color attribute, a green color attribute and a blue color attribute;
in response to maneuvering the line:
adjusting the red color attribute at a first rate;
adjusting the green color attribute at a second rate; and
adjusting the blue color attribute at a third rate.
